(19) United States
(12) Patent Application Publication
(10) Pub. No.: US 2006/0171141 A1
(43) Pub. Date: Aug. 3, 2006

(54) Wall-insert type LED lamp

(75) Inventor: Ching-Tien Tsai, Changhua Hsien (TW)

Correspondence Address: NIKOLAI & MERSEREAU, P.A., 900 SECOND AVENUE SOUTH, SUITE 820, MINNEAPOLIS, MN, 55402, US

(73) Assignee: HSINN INN ENTERPRISE CO., LTD., Changhua Hsien (TW)

(21) Appl. No.: 11/048,163

(22) Filed: Feb. 1, 2005

(51) Int. Cl. F21V 33/00

(52) U.S. Cl. 362/95

(57) ABSTRACT

A lamp includes a main body, a rotation plug, two fastening members, a power switch, a lamp holder, and a control circuit. Thus, the control circuit controls the light emitting diodes to light and blink in a specific manner so as to present a specific lighting effect, thereby enhancing the aesthetic quality of the lamp.

### BACKGROUND OF THE INVENTION

1. Field of the Invention

The present invention relates to a lamp, and more particularly to a wall-insert type LED lamp that is rotatable freely through 360 degrees.

2. Description of the Related Art

A conventional wall-insert type lamp comprises a lamp holder, a plug mounted on a rear end of the lamp holder and inserted into a wall-insert type socket, an electric bulb mounted in the lamp holder, and a shade mounted on the lamp holder to cover the electric bulb. Thus, when the plug is inserted into the wall-insert type socket, the electric bulb lights to provide an illuminating effect. However, the electric bulb only has a single light manner, thereby decreasing the aesthetic quality of the lamp. In addition, the electric bulb consumes larger electric power, thereby wasting the electric power. Further, the electric bulb is easily worn out during a long-term utilization, thereby decreasing the lifetime of the lamp.

### SUMMARY OF THE INVENTION

In accordance with the present invention, there is provided a lamp, comprising a main body, a rotation plug, two fastening members, a lamp holder, and a control circuit, wherein: the main body includes a first casing and a second casing combined with the first casing; the rotation plug is mounted on the main body and has a first end provided with a rotation disk rotatably mounted on an end face of the first casing of the main body and a second end provided with two blades; the fastening members are secured on the first casing of the main body and are combined with each other to hold the rotation disk of the rotation plug; the lamp holder is mounted on the main body and has an inside provided with a plurality of light emitting diodes; the control circuit is mounted in the main body and includes a circuit board connected to the light emitting diodes of the lamp holder.

The primary objective of the present invention is to provide a wall-insert type LED lamp that is rotatable freely through 360 degrees.

Another objective of the present invention is to provide a lamp, wherein the control circuit controls the light emitting diodes to light and blink in a specific manner so as to present a specific lighting effect, thereby enhancing the aesthetic quality of the lamp.

A further objective of the present invention is to provide a lamp, wherein the lamp employs the light emitting diodes to provide an illuminating effect, thereby saving the electric power.

A further objective of the present invention is to provide a lamp, wherein the light emitting diodes are not easily worn out during a long-term utilization, thereby enhancing the lifetime of the lamp.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a lamp in accordance with the preferred embodiment of the present invention;

FIG. 2 is an exploded perspective view of the lamp as shown in FIG. 1;

FIG. 3 is a plan cross-sectional view of the lamp as shown in FIG. 1;

FIG. 4 is a circuit diagram of the lamp as shown in FIG. 1;

FIG. 5 is a schematic operational view of the lamp as shown in FIG. 3 in use;

FIG. 6 is a schematic operational view of the lamp as shown in FIG. 3 in use; and

FIG. 7 is a circuit diagram of a lamp in accordance with another preferred embodiment of the present invention.

### DETAILED DESCRIPTION OF THE INVENTION

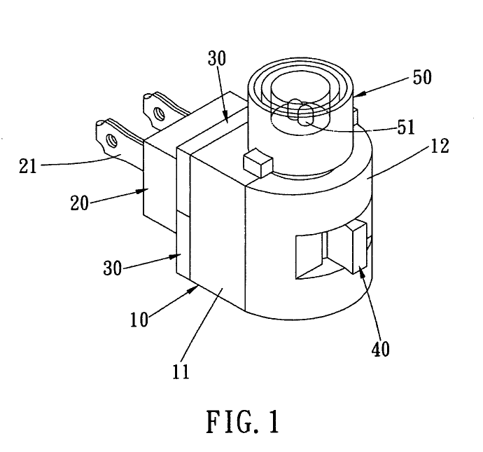

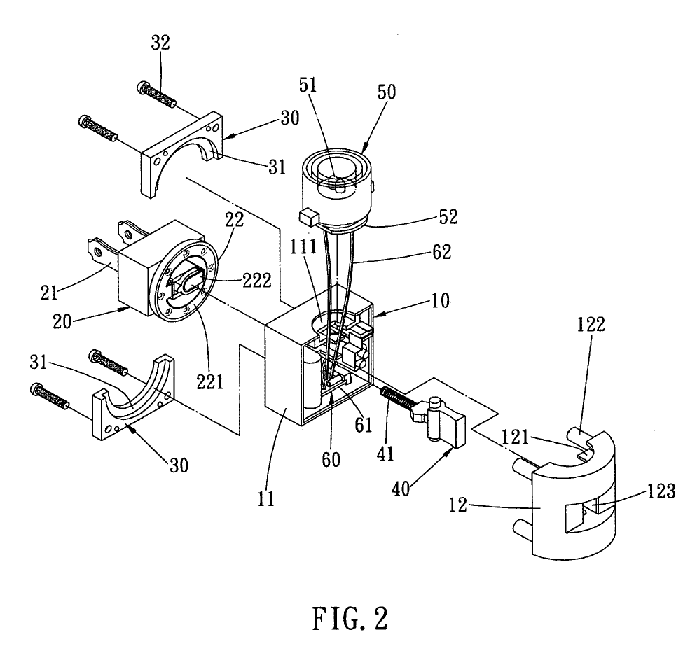

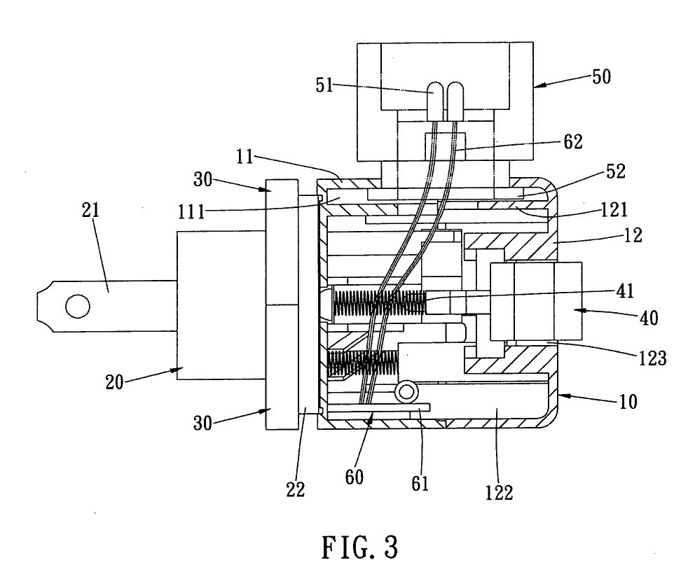

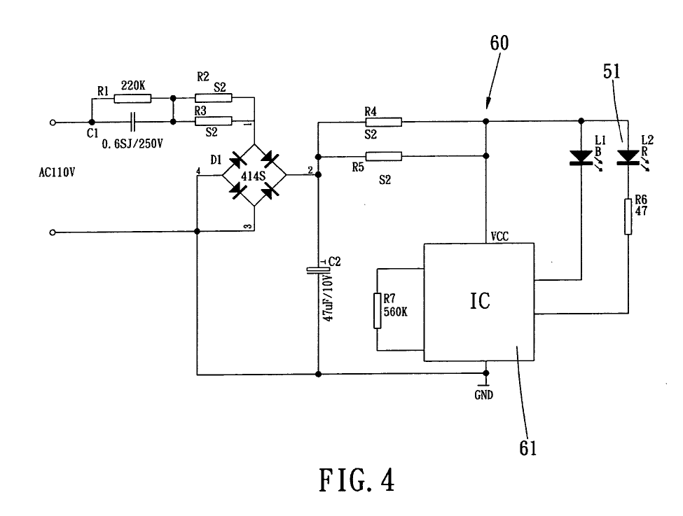

Referring to the drawings and initially to FIGS. 1-4, a lamp in accordance with the preferred embodiment of the present invention comprises a main body 10, a rotation plug 20, two fastening members 30, a power switch 40, a lamp holder 50, and a control circuit 60.

The main body 10 includes a first casing 11 and a second casing 12 combined with the first casing 11. The first casing 11 of the main body 10 has an upper end formed with a first locking groove 111, and the second casing 12 of the main body 10 has an upper end formed with a second locking groove 121 matching the first locking groove 111 of the first casing 11. The second casing 12 of the main body 10 has an inner side provided with a plurality of threaded posts 122 and an outer side formed with a passage 123.

The rotation plug 20 is mounted on the main body 10 and has a first end provided with a rotation disk 22 rotatably mounted on an end face of the first casing 11 of the main body 10 and a second end provided with two blades 21. The rotation disk 22 of the rotation plug 20 has an end face provided with a conducting ring 221 and a conducting plate 222 each connected to the two blades 21.

The fastening members 30 are secured on the first casing 11 of the main body 10 and are combined with each other to hold the rotation disk 22 of the rotation plug 20, so that the rotation disk 22 of the rotation plug 20 is rotatably mounted in the fastening members 30. Each of the two fastening members 30 has a side formed with a semi-circular stepped retaining groove 31 to receive the rotation disk 22 of the rotation plug 20.

The lamp further comprises a plurality of locking bolts 32 each extended through the fastening members 30 and the first casing 11 of the main body 10 and each screwed into a respective one of the threaded posts 122 of the second casing 12 of the main body 10, so that the first casing 11 and the second casing 12 of the main body 10 are combined with each other, the fastening members 30 are secured on the first casing 11 of the main body 10, and the rotation plug 20 is rotatably mounted on the first casing 11 of the main body 10. Thus, the rotation plug 20 is rotatable freely relative to the main body 10 through 360 degrees.

The power switch 40 is pivotally mounted in the main body 10 and has a first end protruding outward from the passage 123 of the second casing 12 of the main body 10. An elastic member 41 is mounted in the main body 10 and biased between the first casing 11 of the main body 10 and a second end of the power switch 40.

The lamp holder 50 is mounted on the main body 10 and located between the first casing 11 and the second casing 12 of the main body 10. The lamp holder 50 has an inside provided with a plurality of light emitting diodes (LED) 51. Preferably, the light emitting diodes 51 of the lamp holder 50 have different colors. The lamp holder 50 has a lower portion formed with a protruding locking flange 52 locked in the first locking groove 111 of the first casing 11 and the second locking groove 121 of the second casing 12 of the main body 10.

The control circuit 60 is mounted in the main body 10 and includes a circuit board 61, a conducting plate, at least one resistor and at least one capacitor. Preferably, the circuit board 61 of the control circuit 60 is mounted in the first casing 11 of the main body 10. The circuit board 61 of the control circuit 60 is connected to the light emitting diodes 51 of the lamp holder 50 by electric wires 62. The circuit board 61 of the control circuit 60 is connected to the conducting ring 221 and the conducting plate 222 of the rotation disk 22 of the rotation plug 20.

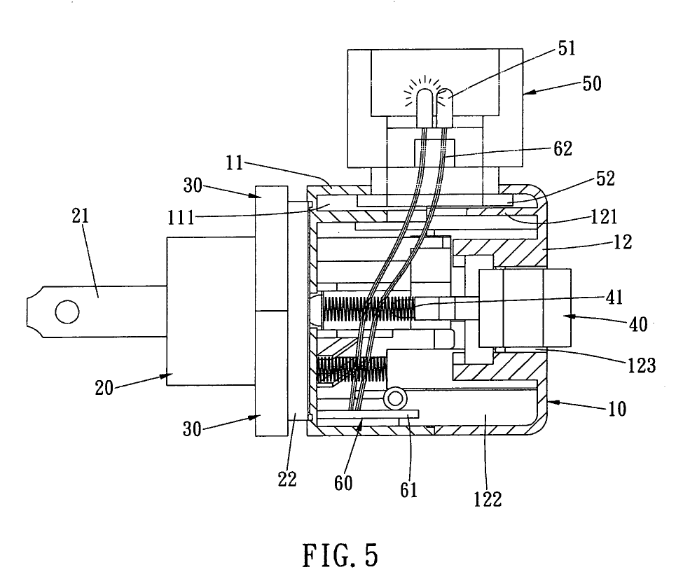

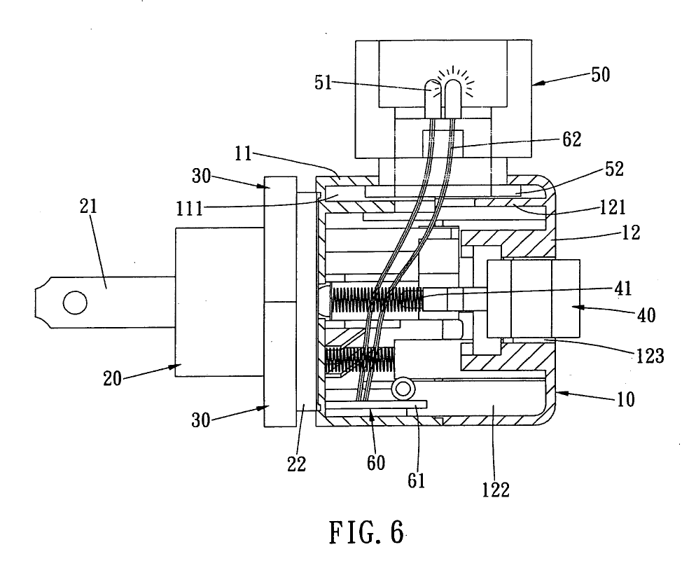

In operation, referring to FIGS. 1-6, the blades 21 of the rotation plug 20 are inserted into a wall-insert type socket. Then, the power switch 40 is turned on, so that the control circuit 60 forms an electrical circuit to introduce an external alternating current from the rotation plug 20 into the control circuit 60. Then, the control circuit 60 drops and rectify the external alternating current from the rotation plug 20 into a direct current which is supplied to the light emitting diodes 51 of the lamp holder 50, so that the light emitting diodes 51 of the lamp holder 50 emit light outward from the lamp holder 50 to provide an illuminating effect. In addition, the control circuit 60 controls the light emitting diodes 51 to light and blink in a specific manner so as to present a specific lighting effect, thereby enhancing the aesthetic quality of the lamp.

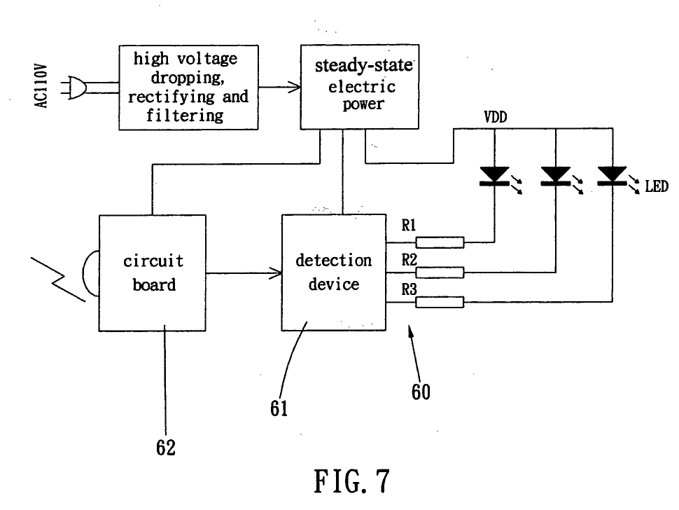

As shown in FIG. 7, the control circuit 60 further includes a detection device 62 connected to the circuit board 61. Thus, when the detection device 62 detects that a human body approaches the lamp, the control circuit 60 forms an electrical circuit to introduce the external alternating current from the rotation plug 20 into the control circuit 60.

Accordingly, the control circuit 60 controls the light emitting diodes 51 to light and blink in a specific manner so as to present a specific lighting effect, thereby enhancing the aesthetic quality of the lamp. In addition, the lamp employs the light emitting diodes 51 to provide an illuminating effect, thereby saving the electric power. Further, the light emitting diodes 51 are not easily worn out during a long-term utilization, thereby enhancing the lifetime of the lamp.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A lamp, comprising a main body, a rotation plug, two fastening members, a lamp holder, and a control circuit, wherein:
the main body includes a first casing and a second casing combined with the first casing;
the rotation plug is mounted on the main body and has a first end provided with a rotation disk rotatably mounted on an end face of the first casing of the main body and a second end provided with two blades;
the fastening members are secured on the first casing of the main body and are combined with each other to hold the rotation disk of the rotation plug;
the lamp holder is mounted on the main body and has an inside provided with a plurality of light emitting diodes;
the control circuit is mounted in the main body and includes a circuit board connected to the light emitting diodes of the lamp holder.

2. The lamp in accordance with claim 1, wherein the light emitting diodes of the lamp holder have different colors.

3. The lamp in accordance with claim 1, wherein the first casing of the main body has an upper end formed with a first locking groove, and the second casing of the main body has an upper end formed with a second locking groove matching the first locking groove of the first casing.

4. The lamp in accordance with claim 3, wherein the lamp holder has a lower portion formed with a protruding locking flange locked in the first locking groove of the first casing and the second locking groove of the second casing of the main body.

5. The lamp in accordance with claim 1, wherein the second casing of the main body has an inner side provided with a plurality of threaded posts, and the lamp further comprises a plurality of locking bolts each extended through the fastening members and the first casing of the main body and each screwed into a respective one of the threaded posts of the second casing of the main body, so that the first casing and the second casing of the main body are combined with each other, the fastening members are secured on the first casing of the main body, and the rotation plug is rotatably mounted on the first casing of the main body.

6. The lamp in accordance with claim 1, wherein the rotation disk of the rotation plug has an end face provided with a conducting ring and a conducting plate each connected to the two blades.

7. The lamp in accordance with claim 6, wherein the circuit board of the control circuit is connected to the conducting ring and the conducting plate of the rotation disk of the rotation plug.

8. The lamp in accordance with claim 1, wherein the rotation disk of the rotation plug is rotatably mounted in the fastening members.

9. The lamp in accordance with claim 1, wherein each of the fastening members has a side formed with a semi-circular stepped retaining groove to receive the rotation disk of the rotation plug.

10. The lamp in accordance with claim 1, further comprising a power switch pivotally mounted in the main body.

11. The lamp in accordance with claim 10, wherein the second casing of the main body has an outer side formed with a passage, and the power switch has a first end protruding outward from the passage of the second casing of the main body.

12. The lamp in accordance with claim 11, further comprising an elastic member mounted in the main body and biased between the first casing of the main body and a second end of the power switch.

13. The lamp in accordance with claim 1, wherein the control circuit further includes a conducting plate, at least one resistor and at least one capacitor.

14. The lamp in accordance with claim 1, wherein the circuit board of the control circuit is mounted in the first casing of the main body.

15. The lamp in accordance with claim 1, wherein the circuit board of the control circuit is connected to the light emitting diodes of the lamp holder by electric wires.

16. The lamp in accordance with claim 1, wherein the lamp holder is located between the first casing and the second casing of the main body.

17. The lamp in accordance with claim 1, wherein the control circuit further includes a detection device connected to the circuit board.

18. The lamp in accordance with claim 1, wherein the control circuit controls the light emitting diodes to light and blink in a specific manner.
